(19) United States
(12) Patent Application Publication
(10) Pub. No.: US 2007/0274528 A1
(43) Pub. Date: Nov. 29, 2007

(54) Acoustic Processing Device

(75) Inventors: Shinji Nakamoto, Kanagawa (JP); Kenichi Terai, Osaka (JP); Kouji Sawamura, Kanagawa (JP); Kazuyuki Tanaka, Kanagawa (JP); Yukihiro Fujita, Kyoto (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/574,137

(22) PCT Filed: Sep. 2, 2005
(86) PCT No.: PCT/JP05/16125

§ 371 Date: Feb. 23, 2007

(30) Foreign Application Priority Data
Sep. 3, 2004 (JP) 2004-257235

(51) Int. Cl. H04S 5/02

(52) U.S. Cl. 381/17

(57) ABSTRACT

A path of a virtual sound source moving through a virtual sound field space and move start and end conditions are input and an effective acoustic signal is generated. An acoustic processing device includes a sound source path input section 12 for inputting path data of a virtual sound source, a sound source position calculation section 13 for successively calculating the move position data of the virtual sound source in response to the path data, a sound source distance calculation section 14 for calculating the distance data between a listener and the virtual sound source, a distance coefficient storage section 15 previously storing coefficient data responsive to the distance between the listening position and the virtual sound source, and an effect sound generation section 17 for selecting any coefficient data in response to the distance data between the listening position and the virtual sound source and generating an effect sound signal obtained about an input sound source signal. According to the configuration, the move path of the virtual sound source moving through the virtual sound field space is specified, the distance to the listening position of the listener is sequentially calculated, and the effective sound signal based on a predetermined distance coefficient is continuously generated from the sound source signal.

### TECHNICAL FIELD

This invention relates to an acoustic processing device and in particular to an acoustic processing device for processing an acoustic signal for localizing a virtual sound source moving through a stereoscopic virtual space for a listener.

### BACKGROUND ART

An acoustic processing device for reproducing a virtual acoustic space wherein when a listener listens to sound of a sound source, he or she is made to recognize the direction and the distance of the sound by controlling output signals of indoor ceiling loudspeakers, headphones, etc., is already commercially practical. The following are known as related arts for reproducing a virtual sound source more strictly or generating and outputting a characteristic acoustic signal for sound image localization with enhanced presence for the listener.

As a sound image localization device for generating an effective acoustic signal when a sound source moves in the far and near direction relative to a listener, a method of generating a delay sound assuming that the distance difference between the direct sound to which the listener listens directly from the sound source and the floor reflection sound reflected on a floor to which the listener listens indirectly, namely, the phase difference is the time difference of sound transmission and performing combining processing with the direct sound is known (for example, refer to patent document 1).

As an acoustic processing system of realizing sound source localization responsive to a move of a sound source including a move of a listener and a move of a fixed sound source, a method of calculating the localization position of the sound source relative to the listener from the attitude data of the listener, namely, the orientation or the position of the listener and the position data of the sound source, namely, the position or the direction of the sound source and generating sound data localized to the virtual absolute position from basic sound data is known (for example, refer to patent document 2).

Further, as a sound field generator for generating a complex sound field and an acoustic signal in a sound field changing with time, a method of connecting a plurality of sound field units for separately processing a sound signal in the sound field space characterized by a sound field parameter, setting the parameters for the units separately, and performing signal processing so that the sound field or the sound source position changes with time is known (for example, refer to patent document 3).
Patent document 1: JP-A-6-30500 (page 4, FIG. 1)
Patent document 2: JP-A-2001-251698 (page 8, FIG. 3)
Patent document 3: JP-A-2004-250563 (page 9, FIG. 2)

### DISCLOSURE OF THE INVENTION

### Problems to be Solved by the Invention

In the related arts described above, an art of inputting the position of a virtual sound source of a virtual space and generating and outputting an acoustic signal involving the appropriate sound effect at the sound source position and the listening position for a sound source signal is disclosed. An art of inputting and setting position data or a parameter in sequence for a moving virtual sound source and localizing the move sound source is also disclosed. In the related arts, however, an acoustic signal is only generated based on the position data of the sound source and a method of inputting conditions of the moving path of the virtual sound source, the move start, the move end, etc., and generating an effective acoustic signal and a method of generating an acoustic signal when limited move path conditions of the start point, the end point, the move time of a moving virtual sound source are input are not recognized or suggested as problems.

It is an object of the invention to provide an acoustic processing device for generating an acoustic signal for localizing a virtual sound source based on path data of a virtual sound source moving through a stereoscopic virtual space. Particularly, it is an object of the invention to provide an acoustic processing device for generating an acoustic signal for localizing a virtual sound source based on a motion expression indicating a localization position and start and end conditions as path data of the virtual sound source. More specifically, it is an object of the invention to provide an acoustic processing device for generating an acoustic signal for a sound source, etc., making a linear uniform move in a predetermined time between the start point and the end point of a moving virtual sound source.

### Means for Solving the Problems

To accomplish the objects of the invention, an acoustic processing device of the invention includes a listening position input section which inputs listening position data of a listener; a sound source path input section which inputs path data of a virtual sound source moving through a virtual sound field space; a sound source position calculation section which successively calculates move position data of the virtual sound source in response to the path data of the virtual sound source input through the sound source path input section; a sound source distance calculation section which calculates localization position data of the virtual sound source and calculates distance data between the listening position and the virtual sound source from the listening position data of the listener input through the listening position input section and the move position data of the virtual sound source calculated in the sound source position calculation section; a distance coefficient storage section which previously stores coefficient data responsive to the distance between the listening position and the virtual sound source; a sound source signal input section which inputs a sound source signal; an effect sound generation section which selects any of the coefficient data stored in the distance coefficient storage section in response to the distance data between the listening position and the virtual sound source calculated in the sound source distance calculation section and generates an effect sound signal about the sound source signal input through the sound source signal input section; and an acoustic signal output section which outputs the effect sound signal generated in the effect sound generation section. According to the configuration, the distance to the listening position of the listener at which the sound source is localized is sequentially calculated from the move path of the virtual sound source moving through the virtual sound field space and the effective sound signal is continuously generated from the sound source signal based on the predetermined distance coefficient.

### ADVANTAGES OF THE INVENTION

The invention can provide the acoustic processing device for sequentially interpolating and calculating the position of the virtual sound source based on the path data of the virtual sound source moving through the virtual space, calculating the distance from the listening position of the listener to the virtual sound source based on the position of the listener and the calculated move position, and generating a sound, thereby reproducing a continuously smooth sound source localization sound.

### BRIEF DESCRIPTION OF THE DRAWINGS

FIG. 1 is a conceptual drawing of the position coordinate relationship between a listener and a moving virtual sound source in a virtual sound field space of an acoustic processing device in a first embodiment of the invention.

FIG. 2 is a block diagram to show the configuration of the acoustic processing device in the first embodiment of the invention.

FIG. 3(a) is a drawing to show a structure example of the listening position data of a listener processed in the acoustic processing device in the first embodiment of the invention; FIG. 3(b) is a drawing to show a structure example of the path data of a virtual sound source processed in the acoustic processing device in the first embodiment of the invention; FIG. 3(c) is a drawing to show a structure example of the move position data of the virtual sound source processed in the acoustic processing device in the first embodiment of the invention; FIG. 3(d) is a drawing to show a structure example of coefficient table data stored in the acoustic processing device in the first embodiment of the invention; and FIG. 3(e) is a drawing to show a structure example of the distance data between the listening position and the virtual sound source processed in the acoustic processing device in the first embodiment of the invention.

FIG. 4 is a drawing to show the relationship among the sections for transferring the data in the acoustic processing device in the first embodiment of the invention.

FIG. 5 is a flowchart of processing of the acoustic processing device in the first embodiment of the invention.

FIG. 6(a) is a conceptual drawing of the position coordinate relationship between a listener and a virtual sound source when the virtual sound source makes a linear uniform move in a virtual sound field space of an acoustic processing device in a second embodiment of the invention and (b) is a conceptual drawing of the position coordinate relationship among a start point and an end point and an intermediate point in moving when the virtual sound source makes a linear uniform move in the virtual sound field space of the acoustic processing device in the second embodiment of the invention.

FIG. 7 is a block diagram to show the configuration of a mode having a localization sound generation function of an acoustic processing device in a third embodiment of the invention.

### DESCRIPTION OF REFERENCE NUMERALS

10 Acoustic processing device
13 Sound source position calculation section
14 Sound source distance calculation section
15 Distance coefficient storage section
17 Effect sound generation section
21 Listening position data
22 Sound source path data
23 Sound source position data
24 Coefficient data
25 Distance data

### BEST MODE FOR CARRYING OUT THE INVENTION

### First Embodiment

An acoustic processing device according to an embodiment of the invention will be discussed with the accompanying drawings. The acoustic processing device of the invention sequentially calculates the distance to the listening position of a listener at which the sound source is localized from the move path of a virtual sound source moving through a virtual sound field space and continuously generates an effective sound signal from a sound source signal based on the calculation result and a predetermined distance coefficient.

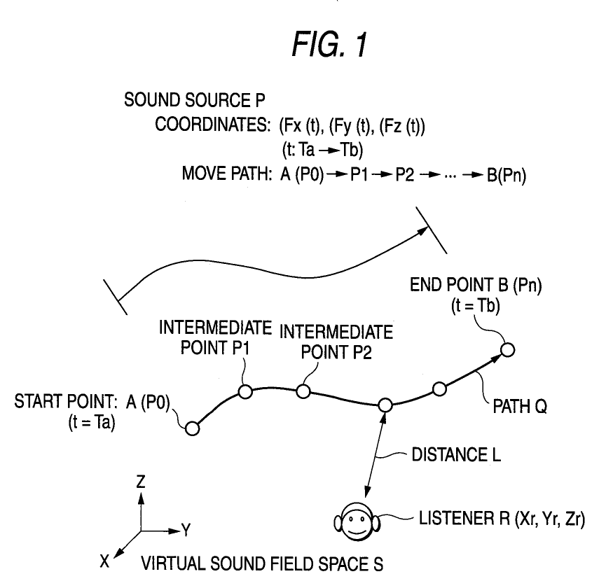

First, the concept of an acoustic processing method of the invention will be discussed. FIG. 1 shows the position coordinate relationship between a listener R and a moving virtual sound source P in a virtual sound field space S. In the virtual sound field space S, the listener R is positioned in coordinates (Xr, Yr, Zr). The virtual sound source P moves along a path Q shown in the figure from a start point A (P0) via intermediate points P1, P2, . . . to an end point B (Pn) from the start point A (P0) to the end point B (Pn). At this time, a position P (t) of the virtual sound source P at an arbitrary time t is found as functions Fx (t), Fy (t), and Fz (t) of the path Q. The acoustic processing device of the invention sequentially calculates the position of the virtual sound source from move path condition data of the virtual sound source P in the position relationship between the listener R and the virtual sound source P in the virtual space and processes a sound source signal responsive to a distance L from the virtual sound source P to generate effect sound and localization sound for the listener R.

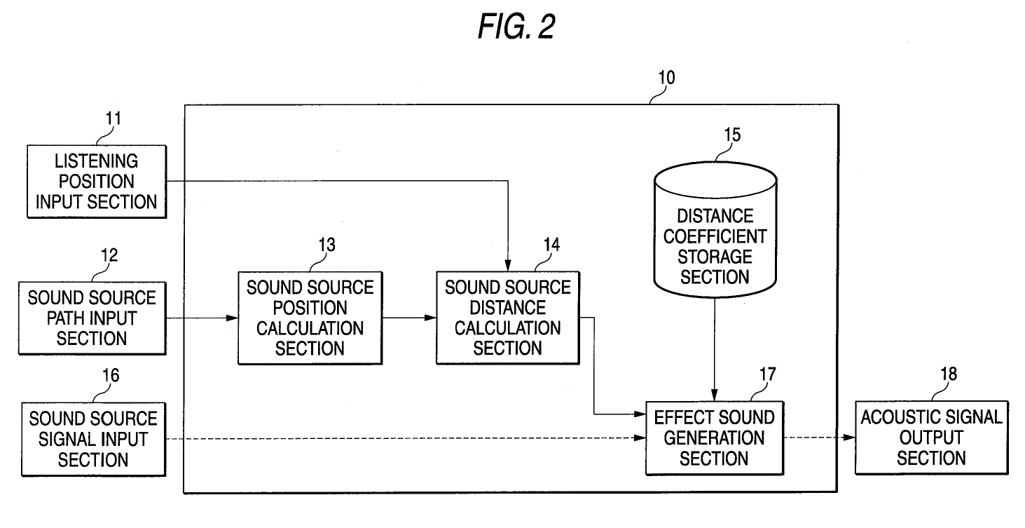

FIG. 2 is a block diagram to show the configuration of acoustic processing device 10 according to the embodiment. In FIG. 2, three input sections, namely, a listening position input section 11, a sound source path input section 12, and a sound source signal input section 16 are connected to the acoustic processing device 10. The listening position input section 11, the sound source path input section 12, and the sound source signal input section 16 may be provided in the acoustic processing device 10. The listening position data of the listener for localizing the virtual sound source in the virtual sound field space is input through the listening position input section 11. The path data of the virtual sound source moving through the virtual sound field space is input through the sound source path input section 12. A sound source signal is input through the sound source signal input section 16.

The acoustic processing device 10 includes a sound source position calculation section 13, a sound source distance calculation section 14, and an effect sound generation section 17 for performing acoustic processing, and includes a distance coefficient storage section 15 in addition to a usual storage section not shown as storage sections. The sound source position calculation section 13 successively calculates the move position data of the virtual sound source in response to the path data of the virtual sound source input from the sound source path input section 12. The sound source distance calculation section 14 calculates the localization position data of the virtual sound source based on the move position data of the virtual sound source calculated in the sound source position calculation section 13 and the listening position data of the listener input from the listening position input section 11 and further calculates the distance data between the listening position and the virtual sound source. The distance coefficient storage section 15 previously stores the coefficient data responsive to the distance between the listening position and the virtual sound source. The effect sound generation section 17 selects any of the coefficient data stored in the distance coefficient storage section 15 in response to the distance data between the listener and the virtual sound source calculated by the sound source distance calculation section 14 and generates an effect sound signal obtained about the sound source signal input from the sound source signal input section 16. The effect sound signal is output from an acoustic signal output section 18 connected to the acoustic processing device 10 in FIG. 2. The acoustic signal output section 18 may be provided in the acoustic processing device 10.

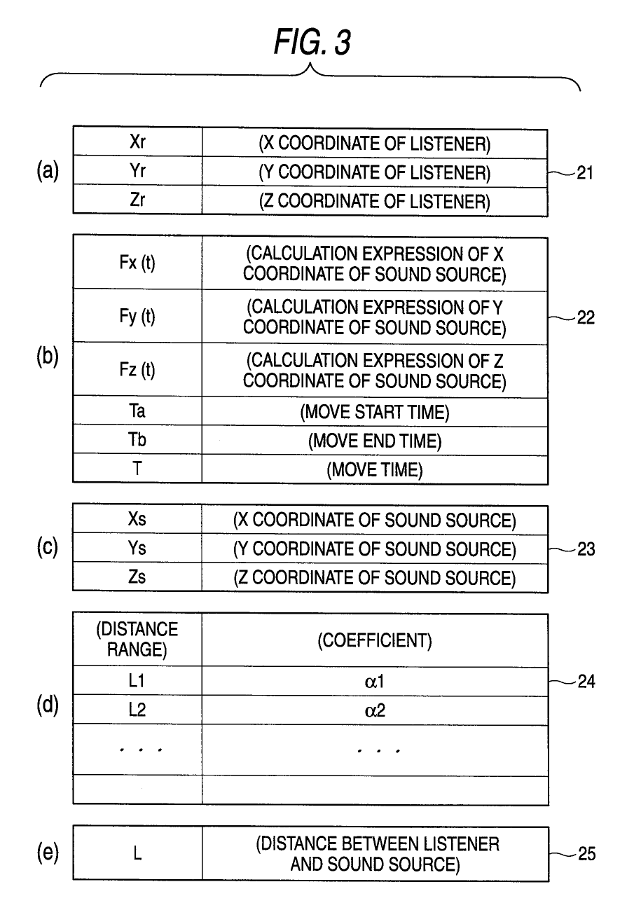

FIG. 3 shows the data structures of the listening position data and the path data input through the listening position input section 11 and the sound source path input section 12, respectively, of the acoustic processing device 10 according to the invention and also shows the data structures of the move position data calculated by the sound source position calculation section 13 and the data stored in the distance coefficient storage section 15 and the data structure of the distance data calculated by the sound source distance calculation section 14.

FIG. 3(a) shows the data structure of listening position data 21 input through the listening position input section 11. As the listening position data 21, X, Y, Z coordinate information of the listener, namely, the values of Xr, Yr, and Zr are input.

FIG. 3(b) shows the data structure of path data 22 of the virtual sound source input through the sound source path input section 12. As the path data 22, calculation expression information representing the X, Y, Z coordinates of the sound source, namely, the functions Fx (t), Fy (t), and Fz (t) of the path Q are input, where Fx, Fy, and Fz are calculation expressions of X coordinate, Y coordinate, and Z coordinate respectively and t is a time variable. Following the calculation expression information, information representing the move start time (Ta), the move end time (Tb), and the move time (T) of the sound source, namely, time information is input.

FIG. 3(c) shows the data structure of move position data 23 calculated by the sound source position calculation section 13. As the move position data 23, the X, Y, Z coordinate information of the sound source, namely, Xs, Ys, and Zs are calculated by the sound source position calculation section 13.

FIG. 3(d) shows the data structure of a coefficient table 24 stored in the distance coefficient storage section 15. The coefficient table 24 stores table data with the distance range (L1) between the listener and the sound source and a coefficient (α1) corresponding to the distance range as one record (L1, α1). If the same coefficient is applied in a measure of distance range, they may be stored collectively as one record like (L11-L12, α11).

FIG. 3(e) shows the data structure of distance data 25 calculated by the sound source distance calculation section 14. As the distance data 25, the distance (L) between the listener and the sound source is calculated by the sound source distance calculation section 14.

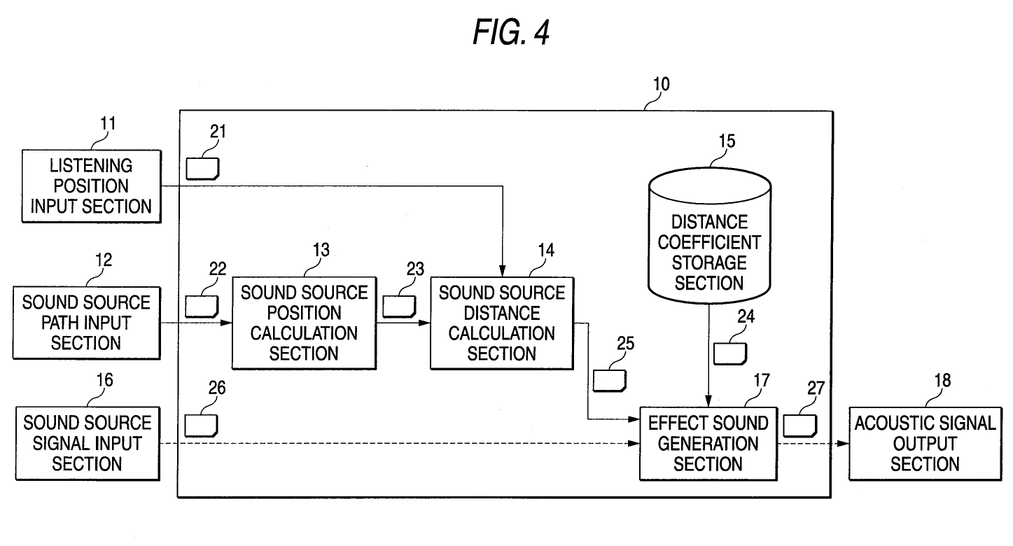

FIG. 4 shows the relationship involved in transfer of the data among the sections of the acoustic processing device 10 according to the embodiment. In FIG. 4, the listening position data 21 input through the listening position input section 11 is input to the sound source distance calculation section 14. The path data 22 input through the sound source path input section 12 is input to the sound source position calculation section 13. The move position data 23 calculated by the sound source position calculation section 13 is input to the sound source distance calculation section 14. The distance data 25 calculated by the sound source distance calculation section 14 based on the listening position data 21 and the move position data 23 is input to the effect sound generation section 17. The coefficient table 24 stored in the distance coefficient storage section 15 based on the distance data 25 is input to the effect sound generation section 17. Sound source signal data 26 input through the sound source signal input section 16 is input to the effect sound generation section 17. An effect sound signal 27 generated in the effect sound generation section 17 from the sound source signal data 26 by referencing the coefficient table 24 is output to the acoustic signal output section 18.

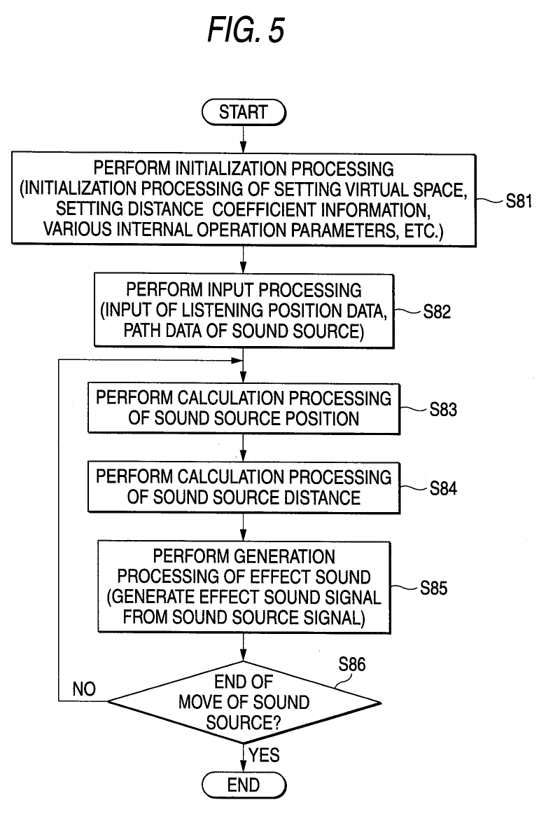

Next, the operation of the acoustic processing device 10 of the invention will be discussed with FIG. 5. FIG. 5 is a flowchart of acoustic processing of the acoustic processing device 10.

When the processing is started, first the data previously stored in internal or external memory, etc., of the acoustic processing device 10 is input and initialization processing of setting a virtual space, setting distance coefficient information, various internal operation parameters, etc., is executed (step S81).

Next, the listening position data 21 of the listener and the path data 22 of the virtual sound source are input and the information is stored in memory, etc., that can be directly accessed inside or outside the acoustic processing device (step S82). The data is referenced during the later processing.

The sound source position calculation section 13 calculates the move position data 23 of the position coordinates of the sound source in response to the internal data time t from the path data 22 (step S83).

Next, the sound source distance calculation section 14 calculates the sound source distance data 25 of the relative distance between the listener and the virtual sound source based on the move position data 23 and the listening position data 21 of the listener (step S84).

Next, the effect sound generation section 18 references the distance coefficient table 24 in the distance coefficient storage section 15 to determine the distance coefficient corresponding to the sound source distance data 25 and performs processing of multiplying the input sound source signal by the distance coefficient, etc., for generating an effect sound signal (step S85).

The internal data time t is changed by a determined value and steps S83 to S85 are repeated until the move end of the sound source. At this time, the value for changing the internal data time t may be set when the acoustic processing device is started.

As described above, in the embodiment of the invention, in the position relationship in the virtual space, the position of the virtual sound source is calculated in sequence from the path data of the virtual sound source and the sound source signal responsive to the distance from the virtual sound source is processed to generate an effective effect sound for the listener.

In the description of the embodiment, the virtual sound source moves in a three-dimensional space, the distance between the virtual sound source and the listening position is calculated, and acoustic processing is performed based on the distance, but the invention is not limited to the case where the virtual sound source moves in a three-dimensional space. The invention can also be applied to the virtual sound source in a two-dimensional space; for example, if position calculation in three-dimensional coordinates is changed to position calculation in two-dimensional coordinates, similar advantages to those of the embodiment described above are produced.

In the description of the embodiment, the mode of operation with one virtual sound source and one input signal has been described; however, even if a plurality of sound sources are applied, if acoustic processing devices are provided in a one-to-one correspondence with the sound sources and the signals processed in the acoustic processing devices are combined for output, the sound image localization effect for the plurality of sound sources can be provided.

In the description of the embodiment, the effect sound generated based on the signal sound is not explicitly pointed out. However, for sound image localization, preferably at least two channels are provided and a right ear signal and a left ear signal are output; more preferably, more than two channels are provided and a surround device signal is output. For the arts of generating signals of multiple channels from a sound source signal, a large number of arts are already commercially practical and therefore the arts will not be discussed in detail.

In the description of the embodiment, processing of the original signal (sound source signal data) using a coefficient selected in response to the distance is not explicitly pointed out. However, a scalar quantity is stored as coefficient information stored in the distance coefficient storage section 15 and the effect sound generation section 17 can generate an amplified effect sound and information concerning a signal filter responsive to the frequency characteristic is stored and an effect sound echoed in a virtual place such as a hall, a theater, a virtual studio, a conference room of an office, a cave, or a tunnel can be generated artificially.

In the description of the embodiment, calculation expression information for calculating the X, Y, Z coordinates of the virtual sound source is input through the sound source path input section 12 and the virtual sound source moves on an arbitrary path, but the invention is not necessarily limited to the case where the calculation expression information is input to the path data 22. When calculation expression information for calculating the position coordinates is not input through the sound source path input section 12 as position information of the sound source and the coordinates of start point A and end point B and move time T from the start point A to the end point B is input, if calculation expression information for calculating the position coordinates when the sound source makes linear uniform motion from the start point A to the end point B, for example, is set as tentative calculation expression information for simply calculating the position coordinates of the sound source by the sound source position calculation section 13, advantages similar to those of the embodiment described above are provided.

### Second Embodiment

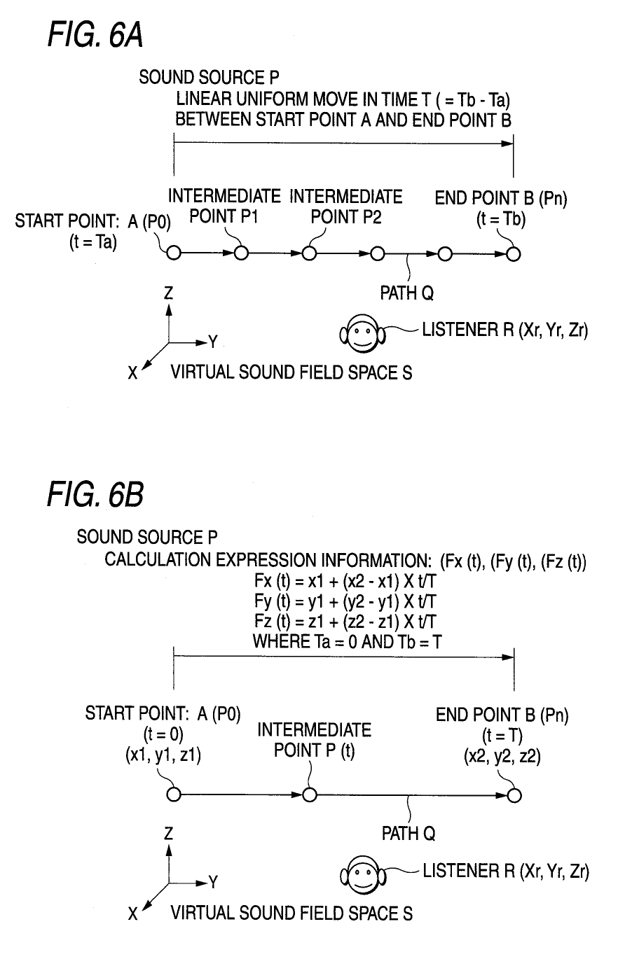

An acoustic processing device according to a second embodiment of the invention will be discussed with FIG. 6. FIG. 6(a) shows the position coordinate relationship between a listener R and a moving virtual sound source P in a virtual sound field space S. In the virtual sound field space S, the listener R is positioned in coordinates (Xr, Yr, Zr). The virtual sound source P is positioned at a start point A (P0) when time t is Ta, and is positioned at an end point B (Pn) when the time t is Tb. Move time T during which the virtual sound source P moves from the start point A (P0) to the end point B (Pn) is the time difference, namely, Tb—Ta. When input of such path data is received, a tentative path on which the virtual sound source P will move is set to a path Q of a line connecting the start point A (P0) and the end point B (Pn). The virtual sound source P moves along the path Q from the start point A (P0) via intermediate points P1 and P2, . . . , to the end point B (Pn) in order and makes a uniform move in the total time T.

Next, setting of tentative calculation expression information at this time will be discussed with FIG. 6(b). FIG. 6(b) shows the relationship among the start point A (P0) and the end point B (Pn) of the moving virtual sound source P in the virtual sound field space S and intermediate point position coordinates P (t) when the sound source is moving on the tentative path Q. The position relationship between the listener R and the virtual sound source P at the move start time and at the move end time is similar to the setting in FIG. 6(a) except that the move start time Ta of the sound source P is set to 0 and the move end time Tb is set to T. In this relationship, the coordinates of the virtual sound source P at the move start time (t=0) are (x1, y1, z1) and the coordinates at the move end time (t=T) are (x2, y2, z2). At this time, for the position P (t) of the virtual sound source P at an arbitrary time t, tentative calculation expression information representing X, Y, and Z coordinates, namely, functions Fx (t), Fy (t), and Fz (t) of the path Q are set as
Fx(t)=x1+(x2−x1)×t/T
Fy(t)=y1+(y2−y1)×t/T
Fz(t)=z1+(z2−z1)×t/T
and the position coordinates can be calculated based on the tentative calculation expression information.

In the description of the embodiment, as the coefficient data stored in the distance coefficient storage section 15, the data previously stored in the internal or external memory, etc., of the acoustic processing device 10 is input and stored at the initialization processing time, but a general network connection section and a distance coefficient update section for downloading coefficient data for rewrite at the specified timing may be provided and the coefficient data stored in the distance coefficient storage section 15 may be updated with the coefficient data downloaded through the network connection section. At this time, the distance coefficient update section can also update the coefficient data for outputting an acoustic signal with an acoustic pattern changing at midpoint even during the acoustic processing of the acoustic processing device 10, but the coefficient data can also be updated waiting for the termination of the acoustic processing so as not to give change to the current signal being output.

### Third Embodiment

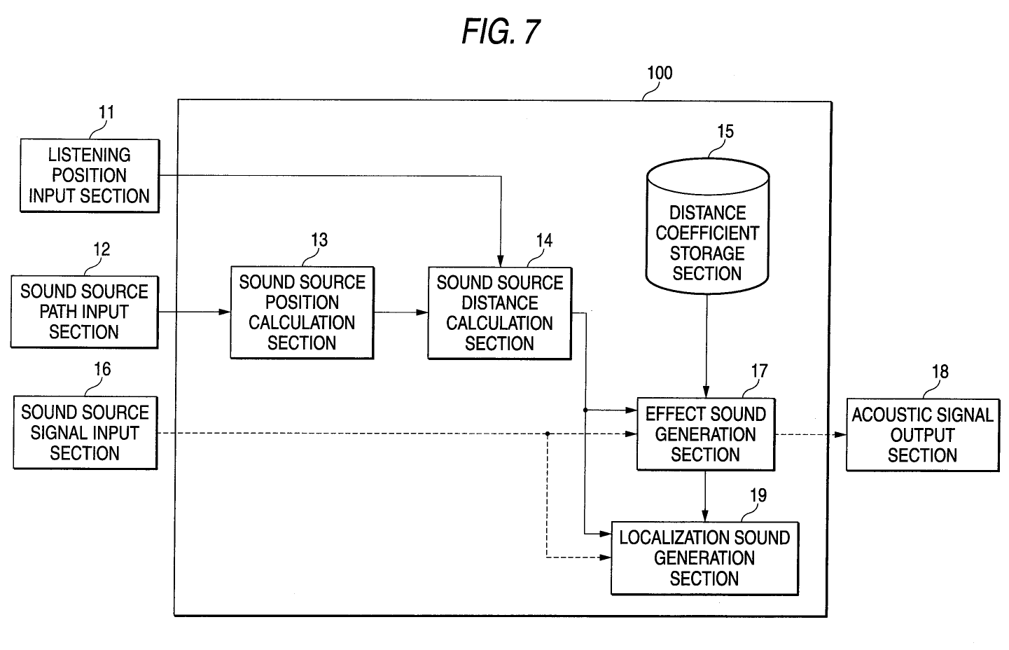

In the description of the first and second embodiments, the reflection effect sound for the original sound source signal is generated. However, as shown in FIG. 7, a localization sound generation section 19 can be further provided for generating a localization sound signal of a direct sound of a sound source signal input through a sound source signal input section 16 in response to distance data 25 between a listener and a virtual sound source calculated in a sound source distance calculation section 14 and further an effect sound generation section 18 can output the localization sound signal together with an effect sound signal generated in an effect sound generation section 17, thereby configuring an acoustic processing device 100 for generating and outputting an acoustic signal with an additional effect sound to a localization sound for the sound source.

While the invention has been described in detail with reference to the specific embodiments, it will be obvious to those skilled in the art that various changes and modifications can be made without departing from the spirit and the scope of the invention.

This application is based on Japanese Patent Application (No. 2004-257235) filed on Sept. 3, 2004, which is incorporated herein by reference.

### INDUSTRIAL APPLICABILITY

The invention can provide the acoustic processing device for sequentially interpolating and calculating the position of the virtual sound source based on the path data of the virtual sound source moving through the virtual space, calculating the distance to the virtual sound source from the position of the listener and the calculated move position, and generating a sound, thereby reproducing a continuously smooth sound source localization sound.

1. An acoustic processing device, comprising:
a listening position input section which inputs listening position data of a listener;
a sound source path input section which inputs path data of a virtual sound source moving through a virtual sound field space;
a sound source position calculation section which calculates move position data of the virtual sound source in response to the path data of the virtual sound source;
a sound source distance calculation section which calculates distance data between the listening position and the virtual sound source based on the listening position data of the listener and the move position data of the virtual sound source;
a distance coefficient storage section which is configured so as to store coefficient data responsive to the distance between the listening position and the virtual sound source;
a sound source signal input section which inputs a sound source signal;
an effect sound generation section which selects any of the coefficient data stored in the distance coefficient storage section in response to the distance data between the listening position and the virtual sound source and processes the sound source signal by using the coefficient data to generate an effect sound signal; and
an acoustic signal output section which outputs the effect sound signal.

2. The acoustic processing device according to claim 1, wherein the sound source distance calculation section calculates localization position data of the virtual sound source based on the listening position data of the listener and the move position data of the virtual sound source,
the acoustic processing device further comprising a localization sound generation section which generates a localization sound signal of a direct sound concerning the sound source signal in response to the localization position data of the virtual sound source, and
wherein the acoustic signal output section outputs the localization sound signal and the effect sound signal.

3. The acoustic processing device according to claim 1, wherein the path data includes calculation expression information indicating the localization position of the virtual sound source at an arbitrary time and time information including at least two data pieces of move start time, move end time, and move time.

4. The acoustic processing device according to claim 3 wherein the path data includes coordinates of the start point and the end point of a move of the virtual sound source and the move time from the move start to end; and
wherein the calculation expression information indicating the localization position of the virtual sound source at an arbitrary time includes a function expression of linear uniform motion to calculate sound source position data.

5. The acoustic processing device according to claim 1, further comprising:
a network connection section which connects to a network; and
a distance coefficient update section which updates the coefficient data stored in the distance coefficient storage section,
wherein coefficient data responsive to the distance between the listening position and the sound source position is downloaded through the network connection section; and
wherein the distance coefficient update section updates the coefficient data stored in the distance coefficient storage section.
